(19) United States
(12) Patent Application Publication
(10) Pub. No.: US 2019/0381845 A1
(43) Pub. Date: Dec. 19, 2019

(54) FRONT LOWER ARM, FRONT SUSPENSION DEVICE AND VEHICLE

(71) Applicant: TOYOTA JIDOSHA KABUSHIKI KAISHA, Toyota-shi (JP)

(72) Inventors: Shinpei MATSUMOTO, Nagoya-shi (JP); Yoshiki Komatsu, Toyota-shi (JP); Takaaki Onodera, Toyota-shi (JP); Atsushi Yaza, Miyoshi-shi (JP)

(73) Assignee: TOYOTA JIDOSHA KABUSHIKI KAISHA, Toyota-shi (JP)

(21) Appl. No.: 16/436,290

(22) Filed: Jun. 10, 2019

(30) Foreign Application Priority Data
Jun. 15, 2018 (JP) 2018-114492

(51) Int. Cl. B60G 3/22; B60G 7/00; B62D 21/15

(52) U.S. Cl. CPC B60G 3/225; B60G 7/005; B60G 2200/156; B62D 21/152; B60G 2800/222; B60G 7/001

(57) ABSTRACT

In the front lower arm, a ball joint bracket to which a ball joint to be coupled to a knuckle is attached is welded to an outer end of a lower arm body in the left and right direction of the vehicle. A spindle member connected to a lower end of a shock absorber is provided on a front side of the ball joint bracket in the front and back direction of the vehicle so as to protrude forward. A welding part between the lower arm body and the ball joint bracket is inclined in plan view, toward an outside in the left and right direction from a front part to a rear part of the welded part in the front and back direction. An extension of a central axial line of the spindle member is arranged so as to intersect with the welded part.

### CROSS-REFERENCE TO RELATED APPLICATIONS

The present application claims priority under 35 U.S.C. § 119(a) to Japanese Patent Application No. 2018-114492, filed on Jun. 15, 2018. The contents of this application are incorporated herein by reference in its entirety.

### TECHNICAL FIELD

The present invention relates to a front lower arm, a front suspension device and a vehicle.

### BACKGROUND ART

Patent Document 1 discloses, for example, a front structure of a front-engine rear-drive (FR) vehicle including a wishbone front wheel suspension.

This structure includes: front side frames that respectively extend toward a vehicle front side from both sides in the vehicle width direction of a vehicle cabin; a subframe that is coupled to the front side frames via a tower part; extension members that are provided on the tower part so as to extend toward the vehicle front side; an upper arm supported by the tower top part; and a lower arm supported by the subframe. A knuckle is attached to the upper arm and the lower arm, and a tie rod is attached to the knuckle.

### PRIOR ART DOCUMENT

Patent Document

Patent Document 1: JP6052121 B2 (JP 2015-058858 A)

### SUMMARY OF THE INVENTION

### Problem to be Solved by the Invention

As one kind of the vehicle offset frontal crash test, a so-called “small overlap frontal crash test” is known.

In the above publicly-known “small overlap frontal crash test”, 25% of the front end of a vehicle on the side of the driver's sheet is subjected to a 40 mph impact (i.e. approximately 64 km/h impact) with a barrier (obstacle).

Here, assuming that the structure disclosed in Patent Document 1 is subjected to the above small overlap frontal crash test, since the front side frames of the vehicle body do not come into a head-on collision with a barrier, the front side frames could absorb less collision energy, which may lead to increase in impact that is input to the cabin (cabin constructional elements) via the front wheel and the like of the vehicle. In this respect, there is a room for improvement.

In consideration of the above circumstances, an object of the present invention is to provide a front lower arm, a front suspension device and a vehicle that are capable of reducing impact that is input to a cabin in a small overlap frontal crash test.

### Means for Solving the Problem

The present invention provides a front lower arm tiltably supported in a state of a cantilever on an outer surface of a side rail that is provided on each side of a vehicle in a left and right direction and that extends in a front and back direction of the vehicle. The front lower arm includes: a lower arm body including an inner pivot that is supported by the side rail at an inner end of the lower arm body in the left and right direction of the vehicle; and a ball joint bracket that is connected, by welding, to an outer end of the lower arm body in the left and right direction of the vehicle. To the ball joint bracket, a ball joint to be coupled to a knuckle is attached. A spindle member, which is connected to a lower end of a shock absorber or an end of a stabilizer link, is provided on a front side of the ball joint bracket in the front and back direction of the vehicle so as to protrude forward in the front and back direction of the vehicle. A welding part between the lower arm body and the ball joint bracket is inclined in plan view, toward an outside in the left and right direction of the vehicle from a front part to a rear part of the welded part in the front and back direction of the vehicle. An extension of a central axial line of the spindle member is arranged so as to intersect with the welded part constituted of an inclined surface.

With this configuration, for example, when a small overlap frontal crash test is conducted, one front wheel is collided with a barrier, and after that, the spindle member comes into contact with the barrier. Accordingly, an impact load that is transmitted from the front side to the rear side in the front and back direction of the vehicle is input to the welded part. However, since the welded part is inclined, the welded part is not likely to be separated.

Thus, the impact load that is input to the front wheel and the front lower arm can be efficiently transmitted to the side rail. In this way, the side rail can absorb collision energy, which can reduce the impact that is input to the cabin.

In the above-described front lower arm, the lower arm body may be formed so as to have a box shape by combining an upper plate member with a lower plate member, and the outer end of the lower arm body in the left and right direction of the vehicle may be made as an opening.

The ball joint bracket may be made of a forging, and an inner end part thereof in the left and right direction of the vehicle may be made so as to have an outer shape to be fitted into the opening of the lower arm body. The welded part may be formed by welding an outer periphery of the inner end part of the ball joint bracket to an end surface of the opening of the lower arm body in a state in which the inner end part is fitted into the opening.

Here, the shape of the lower arm body, the shape of the ball joint bracket, and a welding manner of the ball joint bracket to the lower arm body are specified.

With this specification, the lower arm body is light-weighted while reliably having a sufficient strength. Also, in addition to the ball joint bracket as a high strength forging, the welded part has a total length as long as possible, which results in improvement in peeling resistance.

The present invention also provides a front suspension device that includes: a front lower arm tiltably supported in a state of a cantilever on an outer surface of a side rail that is provided on each side of a vehicle in a left and right direction and that extends in a front and back direction of the vehicle, the front lower arm including an outer end to which a ball joint to be coupled to a knuckle is attached; a tower part fixed to the side rail so as to support an upper end of a shock absorber; a front upper arm tiltably supported in a state of a cantilever by the tower part, the front upper arm including an outer end to which a ball joint is attached; and a knuckle configured to rotatably support a hub to which a front wheel is attached, the knuckle including: a lower side coupling part that is coupled to the ball joint of the front lower arm; and an upper side coupling part that is coupled to the ball joint of the front upper arm. The front lower arm has the configuration as described above.

The front suspension device includes the front lower arm. Thus, when a small overlap frontal crash test is conducted, for example, the impact load that is input to the front wheel and the front lower arm can be efficiently transmitted to the side rail. In this way, the side rail can absorb collision energy, which can reduce the impact that is input to the cabin.

Furthermore, the present invention provides a vehicle that includes: a side rail that is provided on each side of the vehicle in a left and right direction and that extends in a front and back direction of the vehicle; a front suspension device attached to an outer side of the side rail in the left and right direction of the vehicle; and a cabin disposed backward the front suspension device in the front and back direction of the vehicle. The front suspension device has the configuration as described above.

The vehicle includes the front suspension device. Thus, when a small overlap frontal crash test is conducted, for example, the impact load that is input to the front wheel and the front lower arm can be efficiently transmitted to the side rail. In this way, the side rail can absorb collision energy, which can reduce the impact that is input to the cabin.

### Advantageous Effect of the Invention

With a front lower arm, a front suspension device and a vehicle of the present invention, it is possible to reduce impact that is input to a cabin in a small overlap frontal crash test.

### BRIEF DESCRIPTION OF THE DRAWINGS

FIG. 1 is a plan view illustrating an embodiment of a front lower arm of the present invention.

FIG. 2 is an exploded perspective view of the front lower arm in FIG. 1.

FIG. 3 is a cross-sectional view taken from line (3)-(3) of FIG. 1.

FIG. 4 is a diagram of a front suspension device including the front lower arm shown in FIGS. 1 to 3, viewed from a front of a vehicle.

FIG. 5 is a diagram when FIG. 4 is viewed from the outside of the vehicle, from which a disc brake and a knuckle are omitted.

FIG. 6 is a bottom view of a vehicle including the front suspension device in FIG. 4, which indicates a state in which a front wheel is collided with a barrier in a small overlap frontal crash test.

FIG. 7 is a bottom view indicating a subsequent state of the state in FIG. 6, specifically, the state in which a spindle member of the front lower arm is collided with the barrier.

FIG. 8 is a plan view illustrating another embodiment of the front lower arm of the present invention.

FIG. 9 is an exploded perspective view of the front lower arm in FIG. 8.

FIG. 10 is a cross-sectional view taken from line (10)-(10) of FIG. 8.

FIG. 11 is a diagram of a front suspension device including the front lower arm shown in FIGS. 8 to 10, viewed from a front of a vehicle.

FIG. 12 is a diagram when FIG. 11 is viewed from the outside of the vehicle, from which a disc brake and a knuckle are omitted.

### DESCRIPTION OF EMBODIMENT

Hereinafter, a preferred embodiment of the present invention will be described in detail with reference to the appended drawings.

A vehicle to which the present invention is applied has a configuration including, at least: left and right side rails provided on both sides of a vehicle in the left and right direction (also referred to as a “vehicle width direction”) so as to extend in a front and back direction (also referred to as a “vehicle length direction”); left and right front suspension devices; and a cabin (cabin constructional elements).

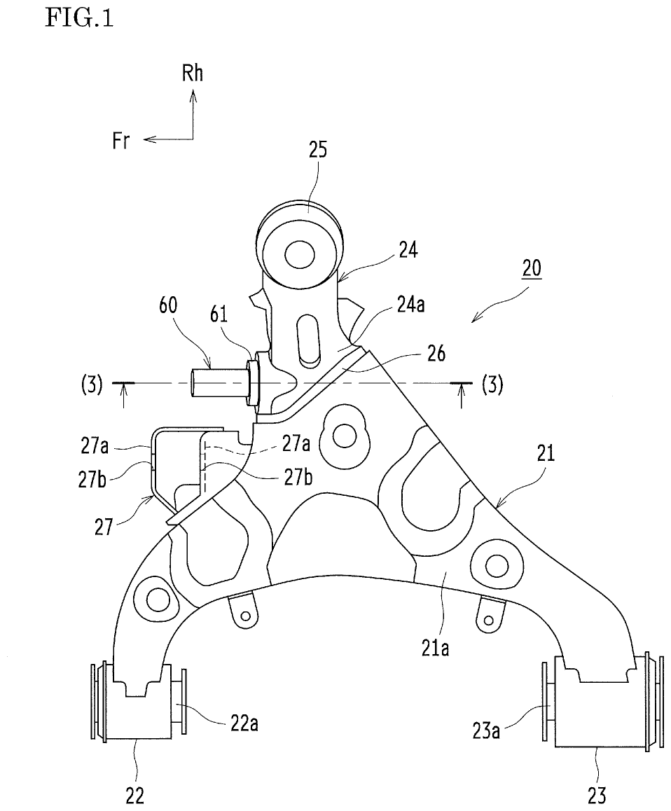

In the embodiment of the present invention shown in FIGS. 1 to 7, only a right front part of the vehicle is shown. That is, the configuration of a left front part of the vehicle is basically the same as the configuration of the right front part of the vehicle, although it is not shown.

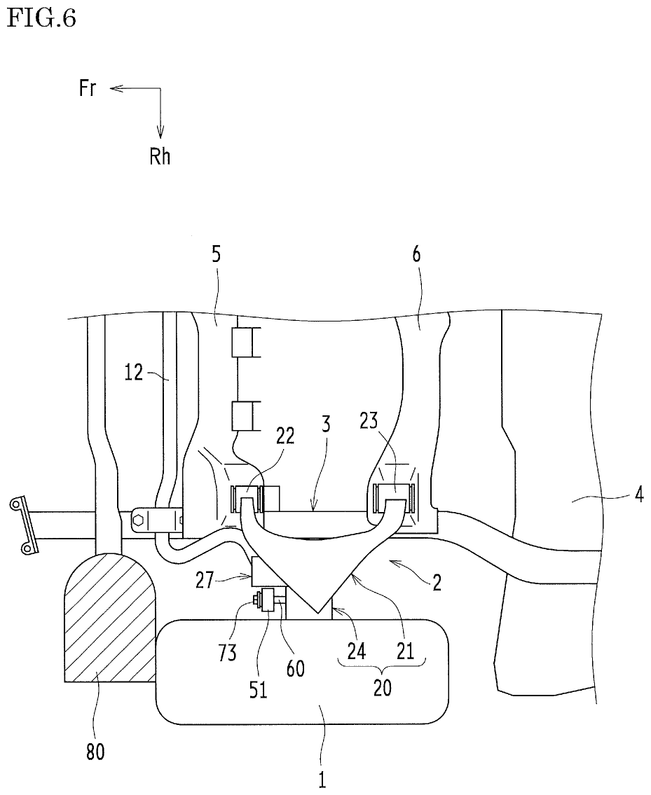

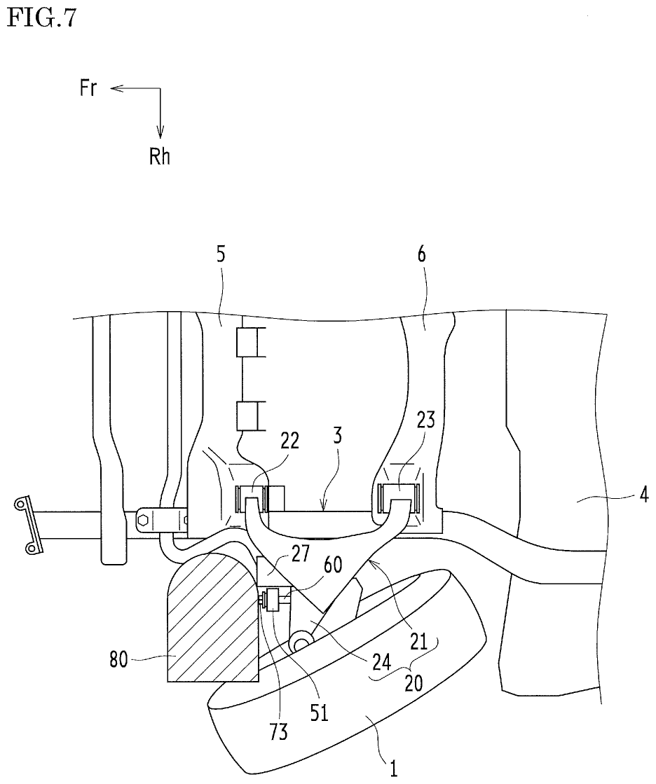

FIGS. 6 and 7 include a right front wheel 1, a right front suspension device 2, a right side rail 3, and a cabin 4.

Between the right side rail 3 and a left side rail (not shown), two (front and back) cross members 5 and 6 are bridged along the left and right direction of the vehicle so as to be parallelly spaced apart from each other relative to the front and back direction of the vehicle.

The cabin 4 is disposed backward the front suspension device 2 in the front and back direction of the vehicle.

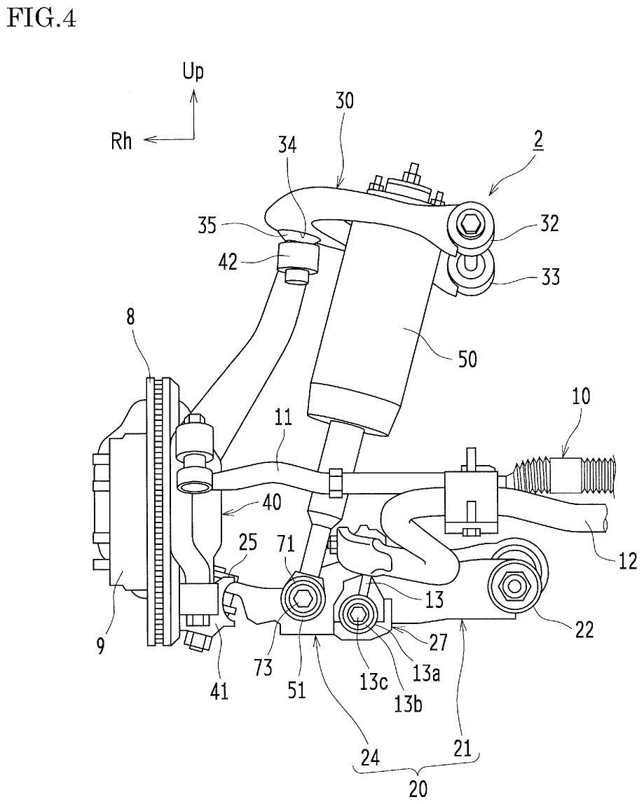

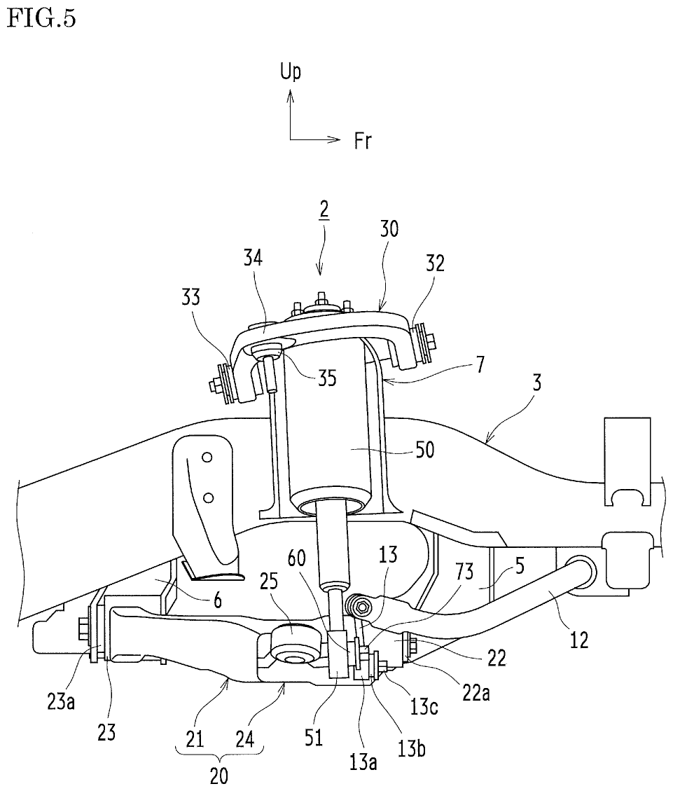

As shown in FIGS. 4 and 5, the front suspension device 2 has a high-mounted upper arm type double wishbone structure, and includes: a front lower arm 20; a front upper arm 30; a knuckle 40; a shock absorber 50; and the like.

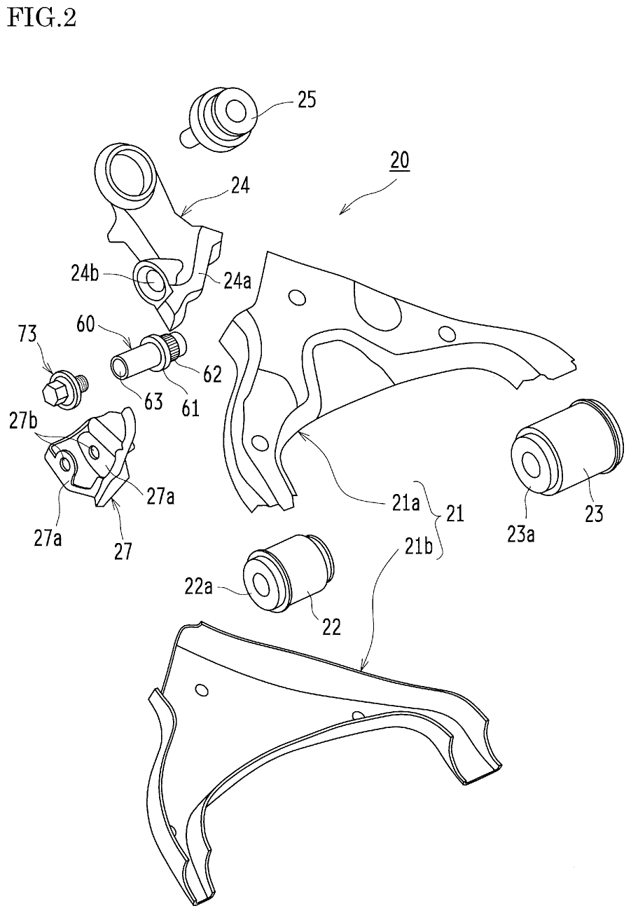

The front lower arm 20 is tiltably supported in a state of a cantilever that protrudes outside, from an outer surface of the side rail 3, in the left and right direction of the vehicle. As shown in FIGS. 1 and 2, the front lower arm 20 includes: a lower arm body 21; two (front and back) inner pivots 22 and 23; and a ball joint bracket 24.

As shown in FIG. 1, the lower arm body 21 is formed so as to have a triangle-like shape whose width gradually decreases from the side of the side rail 3 to the outside in the left and right direction of the vehicle in plan view.

The two (front and back) inner pivots 22 and 23 are each formed so as to have a cylinder shape, and each are welded to a corresponding one of two branched parts of the lower arm body 21 at the inside of the left and right direction of the vehicle.

The front inner pivot 22 is supported, via a bush 22a and a support pin (not shown), by the front cross member 5 fixed to the side rail 3. The rear inner pivot 23 is supported, via a bush 23a and a support pin (not shown), by the rear cross member 6 fixed to the side rail 3.

Thus, in this embodiment, the front inner pivot 22 is indirectly supported by the side rail 3 via the front cross member 5 while the rear inner pivot 23 is indirectly supported by the side rail 3 via the rear cross member 6.

The ball joint bracket 24 is made of a high strength forging that is welded to the lower arm body 21. A ball joint 25 is attached to the ball joint bracket 24. A lower side coupling part 41 of the knuckle 40 is coupled to the ball joint 25.

The front upper arm 30 is tiltably supported in a state of a cantilever that protrudes outside in the left and right direction of the vehicle from a tower part 7 fixed to the side rail 3. The front upper arm 30 includes: an upper arm body 31; two (front and back) inner pivots 32 and 33; and a ball joint mounting part 34.

The upper arm body 31 is formed so as to have a U-shaped one-piece structure in plan view.

The two (front and back) inner pivots 32 and 33 are each formed so as to have a cylinder shape, and are each formed integrally with a corresponding one of two branched parts of the upper arm body 31 at the inside of the left and right direction of the vehicle.

The front inner pivot 32 and the rear inner pivot 33 are respectively supported, via bushes 32a and 33a and support pins (not shown), by the tower part 7, as shown in FIG. 5.

The ball joint mounting part 34 is constituted of a through hole formed in the upper arm body 31. A ball joint 35 is attached to the ball joint mounting part 34. An upper side coupling part 42 of the knuckle 40 is coupled to the ball joint 35.

The knuckle 40 rotatably supports a hub 9 to which a front disc brake 8 and the front wheel 1 are attached. The knuckle 40 includes: the lower side coupling part 41 to which the ball joint bracket 24 of the front lower arm 20 is coupled; and the upper side coupling part 42 to which the ball joint 35 of the front upper arm 30 is coupled.

The upper end of the shock absorber 50 is supported by the tower part 7 while the lower end thereof is supported by a spindle member 60 (described later) of the front lower arm 20. A cylinder part 51 is provided at the lower end of the shock absorber 50.

A power steering device 10, which operates in response to a steering wheel operation, is coupled to the knuckle 40 via a tie rod 11. Also, a stabilizer link 13, which is disposed at an end of a stabilizer 12 (in the Figure, at the right end), is coupled to the front lower arm 20 inside the attached position of the shock absorber 50 in the left and right direction of the vehicle.

Here, detail descriptions will be given on the bonded structure of the lower arm body 21 and the ball joint bracket 24 in the front lower arm 20, as well as on the attached state of the lower end of the shock absorber 50 to the front lower arm 20.

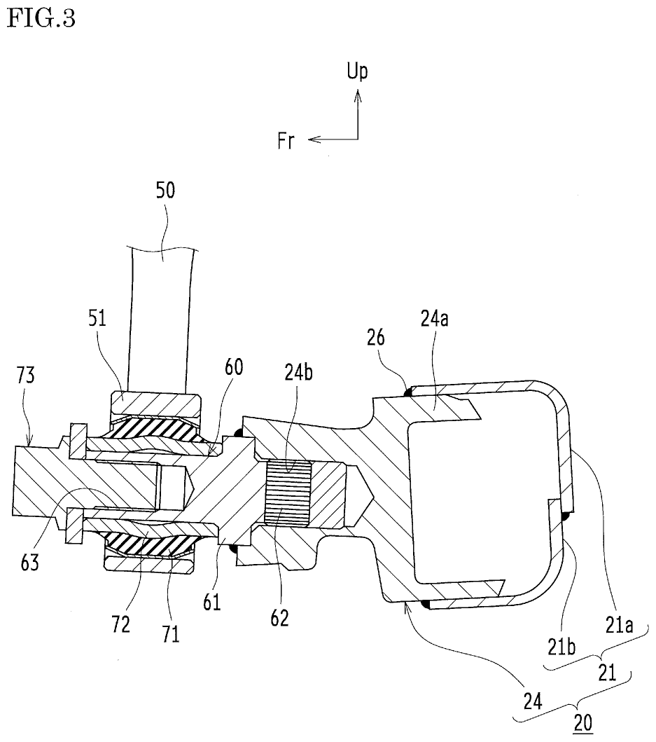

The lower arm body 21 should be light-weighted and reliably have a required strength. For this reason, the lower arm body 21 is formed so as to have a box shape by combining an upper plate member 21a with a lower plate member 21b both made of a metal by press working, as shown in FIGS. 2 and 3.

The outer end of the lower arm body 21 in the left and right direction of the vehicle is opened. Hereinafter, this outer opened part is referred to as an “outer opening”.

The ball joint bracket 24 is made of a high strength forging. An inner end part 24a of the ball joint bracket 24 in the left and right direction of the vehicle is fitted into the outer opening of the lower arm body 21, and thus fixed by welding.

Specifically, as shown in FIG. 3, the inner end part 24a of the ball joint bracket 24 in the left and right direction of the vehicle is formed so as to have an outer shape to be fitted into the outer opening of the lower arm body 21. An internal spline hole 24b is provided in the front part of the ball joint bracket 24 in the front and back direction of the vehicle.

A welded part 26 is formed by welding the outer periphery of the inner end part 24a of the ball joint bracket 24 to the end surface of the outer opening of the lower arm body 21 in a state in which the inner end part 24a is fitted into the outer opening.

As shown in FIG. 1, the welded part 26 is inclined, in plan view, toward the outside in the left and right direction of the vehicle from the front part to the rear part of the welded part 26 in the front and back direction of the vehicle.

The spindle member 60 supports the lower end of the shock absorber 50. The spindle member 60 is disposed so as to protrude forward in the front and back direction of the vehicle from the front side of the ball joint bracket 24 in the front and back direction of the vehicle.

A flange 61 is provided on an intermediate part of the spindle member 60 in the axial direction so as to protrude outward in the radial direction. Spline teeth 62 are formed on an outer peripheral surface of the spindle member 60 on one end side in the axial direction relative to the flange 61. Also, an internal thread hole 63 is provided in an inner part of the spindle member 60 on the other end side in the axial direction relative to the flange 61.

Here, the attached state of the spindle member 60 to the ball joint bracket 24 is described in detail.

As shown in FIG. 3, the spline teeth 62 of the spindle member 60 on the one end side in the axial direction are spline-fitted into the internal spline hole 24b of the ball joint bracket 24. In this state, the contact part of the flange 61 of the spindle member 60 with the opening end of the internal spline hole 24b of the ball joint bracket 24 is welded.

Then, the cylinder part 51 at the lower end of the shock absorber 50 is fitted into the spindle member 60 via a bush 71 and a collar 72, and a bolt 73 is screwed with the internal thread hole 63 of the spindle member 60. Thus, the lower end of the shock absorber 50 is fixed to the spindle member 60.

The bush 71 is expanded in the radial direction by compression deformation of the collar 72 due to the screwed degree of the bolt 73. Thus, the clearance between the lower end of the shock absorber 50 and the spindle member 60 is eliminated.

When the spindle member 60 is attached to the ball joint bracket 24 as described above, the extension of the central axial line of the spindle member 60 is arranged so as to intersect with the inclined welded part 26 (see FIG. 1).

A stabilizer link bracket 27 is fixed to a front part of the lower arm body 21 in the front and back direction of the vehicle.

As shown in FIG. 2, the stabilizer link bracket 27 is formed so as to have two side walls 27a parallelly facing each other. A predetermined part of the stabilizer link bracket 27 is fixed to the lower arm body 21 by welding or the like.

The two side walls 27a facing each other of the stabilizer link bracket 27 each have a through hole 27b into which a screw shaft (not shown) of a bolt 13c is inserted.

Here, the process in which the stabilizer link 13 is attached to the stabilizer link bracket 27 is described.

A bush 13b is inserted into a cylinder part 13a of the stabilizer link 13, and the cylinder part 13a is disposed between the two side walls 27a of the stabilizer link bracket 27. Then, the bolt 13c is inserted into a central hole of the bush 13b and the through holes 27b of the two side walls 27a, and a nut (not shown) is screwed with the tip end of the screw shaft of the bolt 13c. Thus, the stabilizer link 13 is fixed to the stabilizer link bracket 27.

Here, a description will be given on the case in which a vehicle including the above-described front lower arm 20 and the front suspension device 2 is subjected to the above-described small overlap frontal crash test with reference to FIGS. 6 and 7.

In the publicly-known small overlap frontal crash test, 25% of the front end of a vehicle on the side of the driver's sheet is subjected to a 40 mph impact (i.e. approximately 64 km/h impact) with a barrier (obstacle). For example, the front wheel 1 is collided with a barrier 80 as shown in FIG. 6, and after that, the front wheel 1 is rotated outward in the right steering direction while the spindle member 60 and the bolt 73 of the front lower arm 20 are collided with the barrier 80 as shown in FIG. 7.

Accordingly, an impact load that is transmitted from the front side to the rear side in the front and back direction of the vehicle is input to the welded part 26 of the front lower arm 20. However, since the welded part 26 is inclined, the welded part is not likely to be separated.

Thus, the impact load that is input to the front wheel 1 and the front lower arm 20 can be efficiently transmitted to the right side rail 3. In this way, the side rail 3 can absorb collision energy, which can reduce the impact that is input to the cabin 4.

Here, the reason why the welded part 26 is hardly separated is explained. For this purpose, a comparative example of the embodiment of the present invention is indicated, in which the spindle member 60 is attached not to the ball joint bracket 24 but to the lower arm body 21 and the welded part 26 is made so as to have a straight line shape along the front and back direction of the vehicle in plan view.

In this comparative example, the welding length of the welded part 26 is smaller than the welding length of the embodiment of the present invention. In addition, since the welded part 26 is in parallel with the input direction of the impact load at the time of the small overlap frontal crash test, the impact load is not dispersed, which results in the welded part 26 being easily separated.

If the welded part 26 is separated, the collision energy absorbed by the side rail 3 decreases, which may lead to increase in the impact that is input to the cabin 4.

In contrast to the above, when the welded part 26 is inclined as shown in the embodiment of the present invention, the welding length increases compared to the comparative example, which can improve the weld strength.

Furthermore, when the extension of the central axial line of the spindle member 60 is arranged so as to intersect with the inclined-shaped welded part 26 as shown in the embodiment of the present invention, the impact load that is input to the welded part 26 is dispersed.

Thus, the welded part 26 is not likely to be separated by cooperation of the above effects.

As described above, with the embodiment of the present invention, it is possible to increase the collision energy that is absorbed by the right side rail 3 compared to the comparative example in, for example, the small overlap frontal crash test. Thus, it is possible to contribute to improvement of robustness thanks to reduction in impact that is input to the cabin 4 via the front wheel 1 and the front lower arm 20.

The present invention is not limited to the above embodiment. All modifications and changes that come within the meaning and range of equivalency of the claims are intended to be embraced therein.

(1) In the above embodiment, the configuration in which the lower end of the shock absorber 50 is coupled to the spindle member 60 is exemplarily described. However, the present invention is not limited thereto.

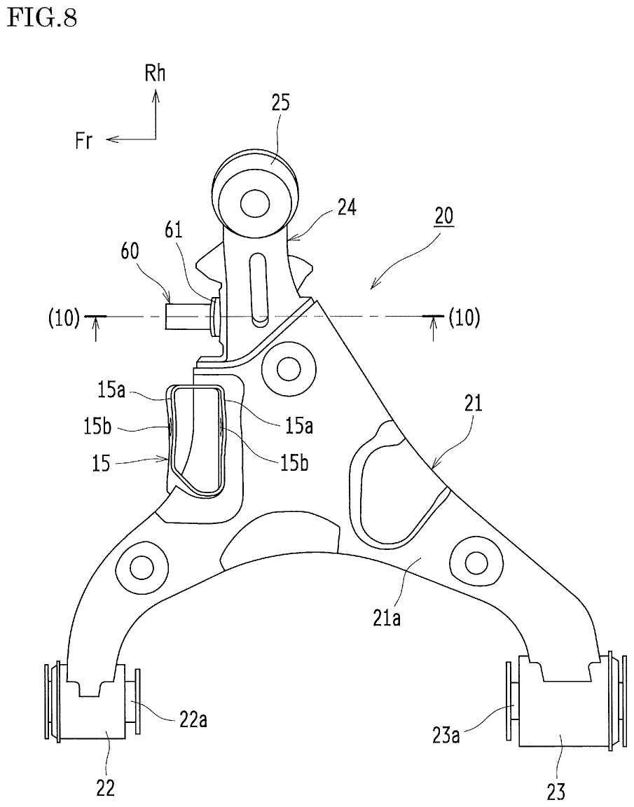

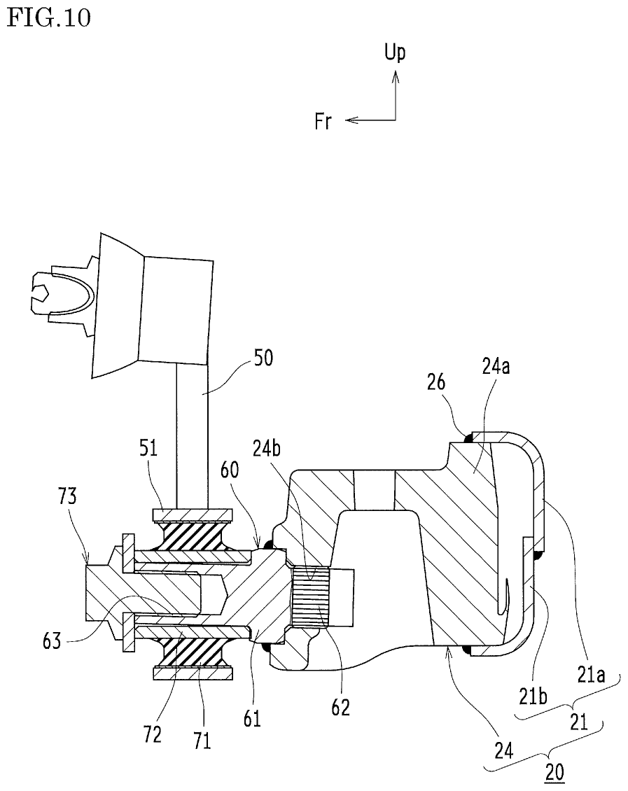

For example, another embodiment of the present invention is indicated in FIGS. 8 to 12. In this embodiment, the stabilizer link 13 is attached to the spindle member 60 of the front lower arm 20, as shown in the Figures. Thus, the cylinder part 51 of the lower end of the shock absorber 50 is supported by a shock absorber bracket 15 of the front lower arm 20 via a bush and a bolt (both not shown).

The shock absorber bracket 15 is attached to the lower arm body 21 of the front lower arm 20 by welding, at a position inside the spindle member 60 in the left and right direction of the vehicle.

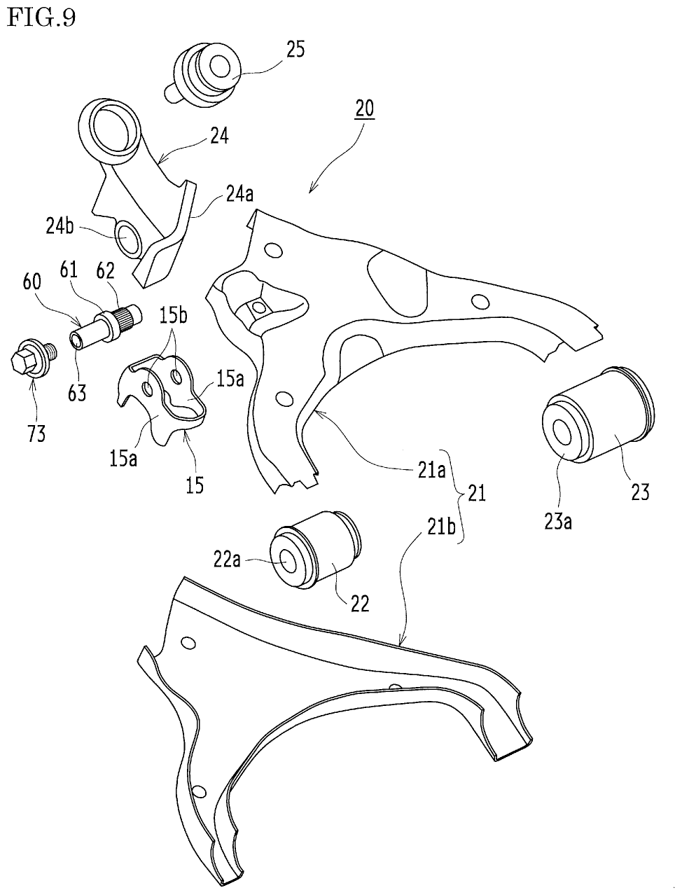

As shown in FIGS. 8 and 9, the shock absorber bracket 15 is formed so as to have a square tube shape, and a lower opening thereof is fixed to the lower arm body 21 by welding or the like.

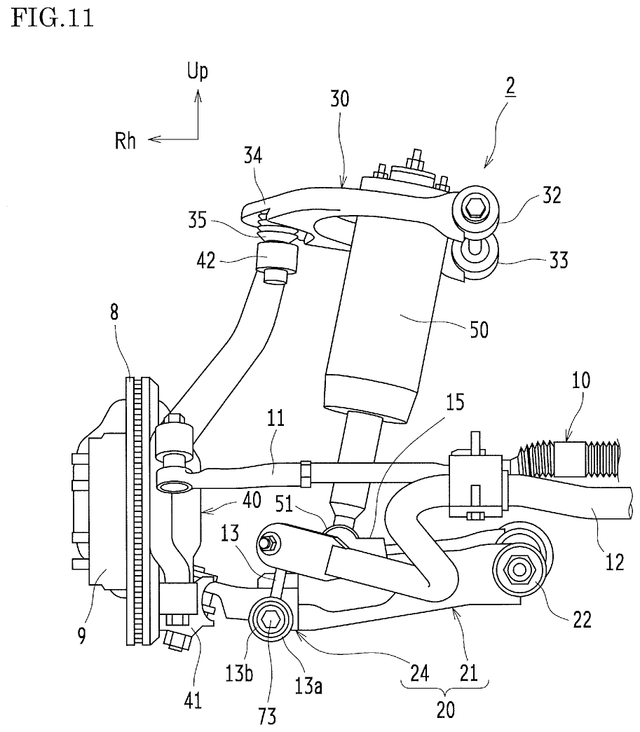

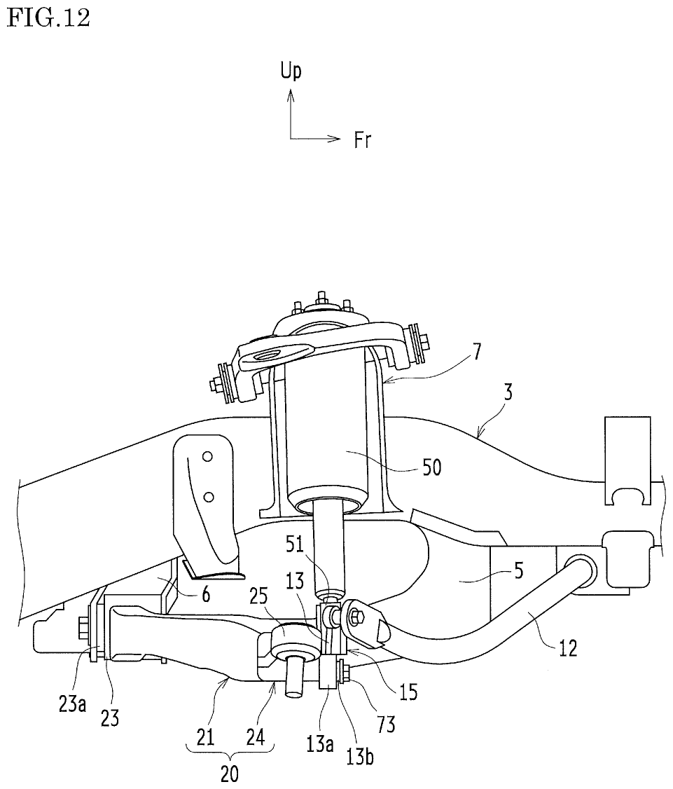

The square tube-shaped shock absorber bracket 15 is formed so as to have a largeness into which the cylinder part 51 (illustrated in only FIGS. 11 and 12) at the lower end of the shock absorber 50 can be fitted.

Two side walls 15a facing each other of the shock absorber bracket 15 each have a through hole 15b (illustrated in only FIGS. 8 and 9) into which the bolt (not shown) is inserted.

Since the configurations other than the above are basically the same as those described in the embodiment, the detail description thereof is omitted.

In this embodiment having the above-described configuration, the states when the small overlap frontal crash test is conducted are not shown in the Figures. However, they are similar to those indicated in FIGS. 6 and 7. That is, the front wheel 1 is collided with the barrier 80, and after that, the front wheel 1 is rotated outward in the right steering direction while the spindle member 60 and the bolt 73 of the front lower arm 20 are collided with the barrier 80.

Accordingly, an impact load that is transmitted from the front side to the rear side in the front and back direction of the vehicle is input to the welded part 26 of the front lower arm 20. However, since the welded part 26 is formed as an inclined surface, the welded part is not likely to be separated.

Thus, the impact load that is input to the front wheel 1 and the front lower arm 20 can be efficiently transmitted to the right side rail 3. In this way, the side rail 3 can absorb collision energy, which can reduce the impact that is input to the cabin 4.

Therefore, with this embodiment also, it is possible to increase the collision energy that is absorbed by the right side rail 3 compared to the comparative example in the small overlap frontal crash test, similarly to the embodiment as described above. Thus, it is possible to contribute to improvement of robustness thanks to reduction in impact that is input to the cabin 4 via the front wheel 1 and the front lower arm 20.

(2) In the above embodiment, the configuration in which the lower arm body 21 of the front lower arm 20 is made by combining the upper plate member 21a with the lower plate member 21b is exemplarily described. However, the present invention is not limited thereto. For example, the configuration in which the lower arm body 21 has a one-piece structure is also included in the present invention, although it is not shown in the Figures.

(3) In the above embodiment, the configuration in which the front lower arm 20 is indirectly supported by the side rail 3 via the front cross member 5 and the rear cross member 6 is exemplarily described. However, the present invention is not limited thereto. For example, the configuration in which the front lower arm 20 is directly supported by the side rail 3 is also included in the present invention, although it is not shown in the Figures.

### INDUSTRIAL APPLICABILITY

The present invention is suitably applied to a front lower arm, a front suspension device and a vehicle.

### REFERENCE SIGNS LIST

1 Right front wheel
2 Right front suspension device
3 Right side rail
4 Cabin
7 Tower part
9 Hub
12 Stabilizer
13 Stabilizer link
20 Front lower arm
21 Lower arm body
22 Front inner pivot
23 Rear inner pivot
24 Ball joint bracket
24a Inner end part
24b Internal spline hole
25 Ball joint
26 Welded part
30 Front upper arm
31 Upper arm body
32 Front inner pivot
33 Rear inner pivot
34 Ball joint mounting part
35 Ball joint
40 Knuckle
41 Lower side coupling part
42 Upper side coupling part
50 Shock absorber
60 Spindle member
61 Flange
62 Spline teeth
63 Internal thread hole
80 Barrier

What is claimed is:

1. A front lower arm tiltably supported in a state of a cantilever on an outer surface of a side rail that is provided on each side of a vehicle in a left and right direction and that extends in a front and back direction of the vehicle, the front lower arm comprising:
a lower arm body including an inner pivot that is supported by the side rail at an inner end of the lower arm body in the left and right direction of the vehicle; and
a ball joint bracket connected, by welding, to an outer end of the lower arm body in the left and right direction of the vehicle, the ball joint bracket to which a ball joint to be coupled to a knuckle is attached, wherein
a spindle member, which is connected to a lower end of a shock absorber or an end of a stabilizer link, is provided on a front side of the ball joint bracket in the front and back direction of the vehicle so as to protrude forward in the front and back direction of the vehicle,
a welding part between the lower arm body and the ball joint bracket is inclined in plan view, toward an outside in the left and right direction of the vehicle from a front part to a rear part of the welded part in the front and back direction of the vehicle, and
an extension of a central axial line of the spindle member is arranged so as to intersect with the welded part constituted of an inclined surface.

2. The front lower arm according to claim 1, wherein
the lower arm body is formed so as to have a box shape by combining an upper plate member with a lower plate member, and the outer end of the lower arm body in the left and right direction of the vehicle is made as an opening,
the ball joint bracket is made of a forging, and an inner end part thereof in the left and right direction of the vehicle is formed so as to have an outer shape to be fitted into the opening of the lower arm body, and
the welded part is formed by welding an outer periphery of the inner end part of the ball joint bracket to an end surface of the opening of the lower arm body in a state in which the inner end part is fitted into the opening.

3. A front suspension device, comprising:
a front lower arm tiltably supported in a state of a cantilever on an outer surface of a side rail that is provided on each side of a vehicle in a left and right direction and that extends in a front and back direction of the vehicle, the front lower arm including an outer end to which a ball joint to be coupled to a knuckle is attached;
a tower part fixed to the side rail so as to support an upper end of a shock absorber;
a front upper arm tiltably supported in a state of a cantilever by the tower part, the front upper arm including an outer end to which a ball joint is attached; and
a knuckle configured to rotatably support a hub to which a front wheel is attached, the knuckle including: a lower side coupling part that is coupled to the ball joint of the front lower arm; and an upper side coupling part that is coupled to the ball joint of the front upper arm, wherein
the front lower arm has the configuration according to claim 1.

4. A vehicle comprising:
a side rail that is provided on each side of the vehicle in a left and right direction and that extends in a front and back direction of the vehicle;
a front suspension device attached to an outer side of the side rail in the left and right direction of the vehicle; and
a cabin disposed backward the front suspension device in the front and back direction of the vehicle, wherein
the front suspension device has the configuration according to claim 3.
